(19) United States
(12) Patent Application Publication
(10) Pub. No.: US 2020/0361029 A1
(43) Pub. Date: Nov. 19, 2020

(54) MACHINE TOOL CONTROL METHOD, MACHINE TOOL CONTROL DEVICE, MACHINE TOOL SETTING ASSISTANCE DEVICE, MACHINE TOOL CONTROL SYSTEM AND PROGRAM

(71) Applicant: MITSUBISHI HEAVY INDUSTRIES MACHINE TOOL CO., LTD., Ritto-shi, Shiga (JP)

(72) Inventors: Saneyuki GOYA, Tokyo (JP); Toshiya WATANABE, Tokyo (JP); Haruhiko NIITANI, Ritto-shi (JP); Yoshihito FUJITA, Ritto-shi (JP)

(73) Assignee: MITSUBISHI HEAVY INDUSTRIES MACHINE TOOL CO., LTD., Ritto-shi, Shiga (JP)

(21) Appl. No.: 16/766,653

(22) PCT Filed: Apr. 25, 2018
(86) PCT No.: PCT/JP2018/016791

§ 371 Date: May 22, 2020

(30) Foreign Application Priority Data
Nov. 30, 2017 (JP) 2017-231017

(51) Int. Cl. B23K 26/08; G05B 19/4097

(52) U.S. Cl. CPC B23K 26/0884; G05B 2219/35012; G05B 2219/45041; G05B 19/4097

(57) ABSTRACT

This machine tool control method has: a step for accepting processing content about a workpiece; a step for referring to a storage unit, which stores, for each piece of processing content, a range of set conditions regarding the movements of a machine tool for performing the processing, and specifying the range of the set conditions corresponding to the accepted processing content; and a step for determining the settings of the movements of the machine tool on the premise of the range of the specified set conditions upon accepting a processing order according to the processing content about the workpiece.

### TECHNICAL FIELD

The present invention relates to a machine tool control method, a machine tool control device, a machine tool control system, a machine tool setting assistance device, and a program. Priority is claimed on Japanese Patent Application No. 2017-231017 filed on Nov. 30, 2017, the content of which is incorporated herein by reference.

### BACKGROUND ART

In recent years, machine tools capable of performing complicated and advanced processing have been provided, and even members that could not be processed conventionally have been treated as processing targets. In a case of performing processing with a machine tool, it is necessary to find and set appropriate processing conditions for each workpiece. In general, before finding appropriate processing conditions, it is necessary to repeat processing many times to determine whether the processing conditions are appropriate. However, a great deal of labor and cost are required for setting of the processing conditions according to the expansion of the processing targets.

In contrast, a method of assisting in the setting of processing conditions has been proposed. For example, PTL 1 discloses a laser processing device in which processing conditions are stored in a memory for each processing shape of workpieces, and if an operator inputs a material, a plate thickness, a processing shape, and the like of the workpiece, appropriate processing conditions according to those conditions are selected to perform processing.

Further, PTL 2 discloses a machine tool control device in which if a certain processing condition (for example, cutting speed) is selected such that a user can set an appropriate value when inputting a processing condition of a machine tool, a calculation formula for calculating the processing condition and an input screen for inputting parameters (for example, the number of rotations of a spindle and a tool diameter) required for the calculation are displayed. If the techniques described in PTLs 1 and 2 are used, there is an advantage that appropriate processing conditions can be efficiently determined.

### CITATION LIST

### Patent Literature

[PTL 1] Japanese Unexamined Patent Application Publication No. 6-142954

[PTL 2] International Publication No. WO 2016/051549

### SUMMARY OF INVENTION

### Technical Problem

However, in the general techniques described in PTL 1 and the like, the processing contents and the processing conditions have a one-to-one correspondence, and in many cases, the processing conditions which are provided by these techniques are processing conditions optimized for certain external conditions. Therefore, the techniques have vulnerability to a change in external condition, and for example, even if processing is performed based on these processing conditions, there is a concern that optimum processing may not be able to be executed due to disturbance such as an installation environment of a machine tool or an individual difference between processing targets.

The present invention provides a machine tool control method, a machine tool control device, a machine tool setting assistance device, a machine tool control system, and a program, in which it is possible to solve the above-described problems.

### Solution to Problem

According to an aspect of the present invention, there is provided a machine tool control method including: a step of receiving a processing content for a workpiece; a step of referring to a storage unit in which a range of a setting condition relating to an operation of a machine tool for performing processing is stored for each processing content, and specifying the range of the setting condition corresponding to the received processing content; and a step of determining setting for an operation of the machine tool on the premise of the specified range of the setting condition, in a case of receiving a processing instruction according to the processing content for the workpiece.

According to an aspect of the present invention, the machine tool control method further includes: a step of acquiring information indicating a result of processing of the workpiece; a step of evaluating the result of processing, based on the processing content; a step of adjusting the range of the setting condition, based on the evaluation; and a step of storing the adjusted range of the setting condition in the storage unit.

According to an aspect of the present invention, the information indicating a result of processing of the workpiece is measurement information obtained by measuring an environment in which the processing is performed or the workpiece by using a sensor, or a value calculated based on the measurement information.

According to an aspect of the present invention, the machine tool control method further includes: a step of reevaluating the range of the setting condition, based on the result of processing and the processing content; and a step of resetting the range of the setting condition in a case where in the revaluation step, it is determined that the range of the setting condition is not appropriate.

According to an aspect of the present invention, in the step of reevaluating the range of the setting condition, the degree of coincidence between a request included in the processing content and a result of the processing with respect to the request is calculated, and if the degree of coincidence is equal to or less than a predetermined threshold value, it is determined that the range of the setting condition is not appropriate.

According to one aspect of the present invention, in the step of acquiring information indicating a result of processing, information on a time when the processing was performed is further acquired, and in the step of resetting the range of the setting condition, the range of the setting condition is reset based on the information indicating the result of processing acquired within a predetermined period on the basis of the acquired time.

According to an aspect of the present invention, the machine tool control method further includes: a step of notifying that the machine tool is not able to be operated under the setting condition as instructed, in a case of receiving an instruction to operate the machine tool under a setting condition outside the range of the setting condition.

According to an aspect of the present invention, the processing content includes at least one of a material of the workpiece, a size of a hole which is formed in the workpiece, and a thickness of the workpiece.

According to an aspect of the present invention, the machine tool is a laser processing machine.

According to an aspect of the present invention, there is a provided a machine tool control device including: a reception unit that receives a processing content for a workpiece; a specifying unit that refers to a storage unit in which a range of a setting condition relating to an operation of a machine tool for performing processing is stored for each processing content, and specifies the range of the setting condition corresponding to the received processing content; and a determination unit that determines setting for an operation of the machine tool on the premise of the specified range of the setting condition, in a case of receiving a processing instruction according to the processing content for the workpiece.

According to an aspect of the present invention, there is provided a machine tool setting assistance device including: a storage unit in which a processing content for a workpiece and a range of a setting condition of a machine tool are stored in association with each other.

According to an aspect of the present invention, the setting assistance device further includes: a range setting unit that sets the range of the setting condition, based on a result of processing of the workpiece according to a predetermined processing content by the machine tool and the processing content.

According to one aspect of the present invention, there is provided a machine tool control system including: the machine tool control device described above; and the machine tool setting assistance device described above, in which the machine tool control device specifies the range of the setting condition associated with the processing content with reference to a storage unit included in the setting assistance device.

According to an aspect of the present invention, there is provided a program for causing a computer of a machine tool control device to execute: a step of receiving a processing content for a workpiece; a step of referring to a storage unit in which a range of a setting condition relating to an operation of the machine tool for performing processing is stored for each processing content, and specifying the range of the setting condition corresponding to the received processing content; and a step of determining setting for an operation of the machine tool on the premise of the specified range of the setting condition, in a case of receiving a processing instruction according to the processing content for the workpiece.

### Advantageous Effects of Invention

According to the above-described machine tool control method, machine tool control device, machine tool setting assistance device, machine tool control system, and program, by providing an appropriate range of a setting condition determined in consideration of disturbance, it is possible to perform setting of the setting condition for the machine tool in a shorter time.

### BRIEF DESCRIPTION OF DRAWINGS

FIG. 1 is a block diagram showing an example of a control system in each embodiment of the present invention.

FIG. 2 is a diagram showing example of processing contents and setting conditions in a first embodiment of the present invention.

FIG. 3 is a first diagram for describing a range of a setting condition in the first embodiment of the present invention.

FIG. 4 is a second diagram for describing a range of a setting condition in the first embodiment of the present invention.

FIG. 5 is a flowchart showing an example of processing of setting a setting condition using a range of a setting condition in the first embodiment of the present invention.

FIG. 6 is a diagram for describing measurement of a processing result in the first embodiment of the present invention.

FIG. 7 is a flowchart showing an example of processing of adjusting a range of a setting condition in a second embodiment of the present invention.

FIG. 8 is a diagram for describing adjustment of a range of a setting condition in the second embodiment of the present invention.

FIG. 9 is a first flowchart showing an example of processing of resetting a range of a setting condition in a third embodiment of the present invention.

FIG. 10 is a second flowchart showing an example of processing of resetting a range of a setting condition in the third embodiment of the present invention.

FIG. 11 is a diagram for describing resetting of a range of a setting condition in the third embodiment of the present invention.

FIG. 12 is a diagram showing an example of a hardware configuration of a control device and an assistance device according to the present invention.

### DESCRIPTION OF EMBODIMENTS

### First Embodiment

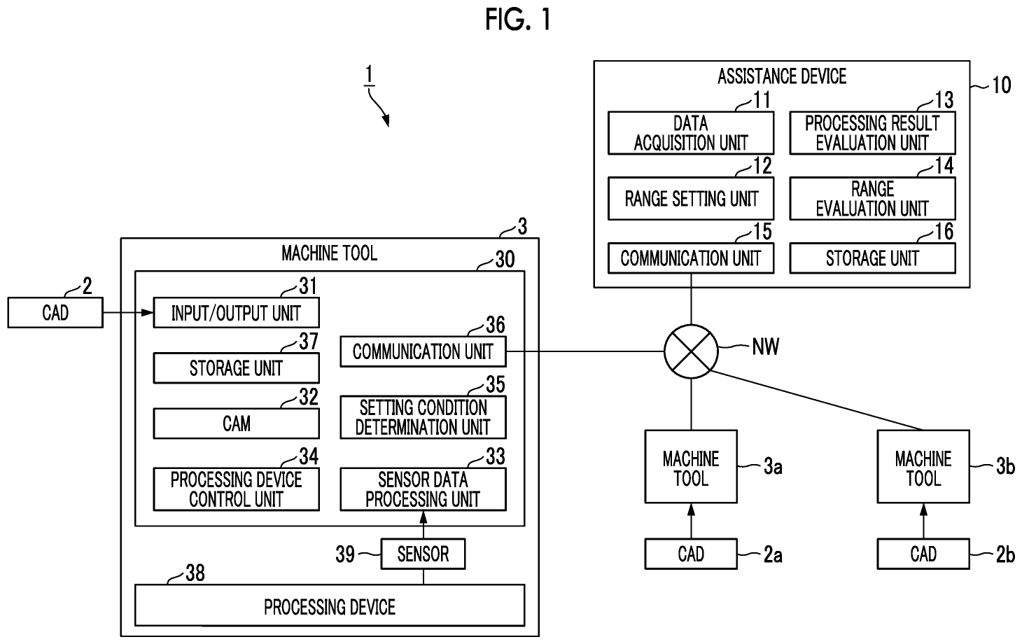

Hereinafter, a machine tool control system according to a first embodiment of the present invention will be described with reference to FIGS. 1 to 6.

FIG. 1 is a block diagram showing an example of the control system in each embodiment of the present invention. A control system 1 provides a function of assisting in setting of setting conditions necessary for processing by machine tools 3, 3a, and 3b. The setting conditions are operating conditions (processing conditions) of the machine tool 3, which are set in the machine tool 3 in order to perform appropriate processing. As shown in FIG. 1, the control system 1 includes an assistance device 10 that assists in the determination of the setting conditions, the machine tools 3, 3a, and 3b, and CAD (computer aided design) systems 2, 2a, and 2b. The assistance device 10 and the machine tools 3, 3a, and 3b are communicably connected to each other through a network (NW). The machine tools 3, 3a, and 3b are collectively referred to as a machine tool 3, and the CAD systems 2, 2a, and 2b are collectively referred to as a CAD system 2. In the control system 1, the number of each of the assistance devices 10, the machine tools 3, and the CAD systems 2 is not limited to the number shown in the drawing. For example, two or more assistance devices 10 may be included, and one or four or more machine tools 3 and one or four or more CAD systems 2 may be included. Further, the machine tools 3, 3a, and 3b may be installed in different factories, respectively, or may be installed in one factory. The assistance device 10 and the CAD system 2 are computers including a CPU (Central Processing Unit) such as a server, for example.

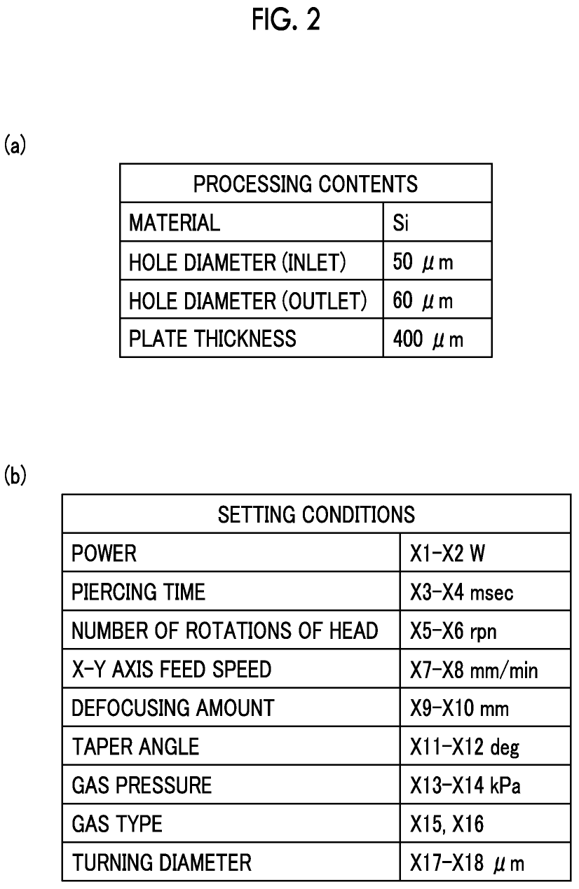

The assistance device 10 provides the machine tool 3 with information indicating a range of a setting condition suitable for a processing content with respect to processing which is performed by the machine tool 3. Further, the assistance device 10 acquires information indicating a processing content (processing content information) and information indicating a processing result (processing result information) with respect to the processing performed by the machine tool 3, determines whether or not the range of the setting condition provided from the assistance device 10 is appropriate, adjusts the range of the setting condition in a case where it is not appropriate, and provides the machine tool 3 with information indicating the adjusted range of the setting condition (range information). Here, the processing contents are a request and a specification of the processing on the workpiece. Next, the processing contents and the ranges of the setting conditions will be described using FIG. 2.

FIG. 2 is a diagram showing examples of the processing contents and the setting conditions in the first embodiment of the present invention. In FIG. 2(a), as an example of the processing content, a processing content indicating that a tapered hole having an inlet hole diameter of “50 μm” and an outlet hole diameter of “60 μm” is formed in a member made of “Si” and having a plate thickness of “400 μm” is shown. The processing content includes not only an item relating to a shape such as a hole diameter or a hole depth but also an item relating to quality. The item relating to the quality includes, for example, the cross-sectional area of a deteriorated layer, the height of a burr, the size of an attached matter, surface roughness, and the like.

FIG. 2(b) shows examples of the ranges of the setting conditions for realizing the processing content. FIG. 2(b) shows examples of the setting conditions in a case where the machine tool 3 is a laser processing machine. The setting conditions of the laser processing machine include, for example, the power of a laser which is output, a piercing time, the number of rotations of a turning head of a laser, an X-Y axis feed speed, a defocus amount, a taper angle, a gas pressure of an assist gas, a gas type, a turning diameter, of a laser, and the like. As shown in the drawing, in this embodiment, the value of each item of the setting conditions is given in a range. As will be described later, the range of each item is a range determined in consideration of the influence of disturbance such as an installation environment of a machine tool and an individual difference (material) of a workpiece.

In the assistance device 10, information on the range of the setting conditions (FIG. 2(b)) suitable for the processing content for each of various processing contents is stored. The assistance device 10 acquires processing content information illustrated in FIG. 2(a) from the machine tool 3, specifies the range information of the setting conditions according to the processing content, and transmits the specified range information to the machine tool 3.

The assistance device 10 includes a data acquisition unit 11, a range setting unit 12, a processing result evaluation unit 13, a range evaluation unit 14, a communication unit 15, and a storage unit 16.

The data acquisition unit 11 acquires processing content information and processing result information from the machine tool 3.

The range setting unit 12 specifies the range information of the setting condition for each processing content information. Further, in a case where the evaluation by the processing result evaluation unit 13 is not good, the range setting unit 12 adjusts the range of the setting condition and stores the range information of the setting condition after the adjustment in the storage unit 16.

The processing result evaluation unit 13 evaluates the processing performed by the machine tool 3, based on the processing content information and the processing result information acquired by the data acquisition unit 11.

The range evaluation unit 14 evaluates whether or not the range of the setting condition set by the range setting unit 12 is appropriate.

The communication unit 15 performs communication with the machine tool 3. For example, the communication unit 15 transmits the range information of the setting condition to the machine tool 3. The communication unit receives the processing content information or the processing result information from the machine tool 3.

The storage unit 16 stores the range information of the setting condition and the processing result information for each processing content. The storage unit 16 stores the processing result information received from a plurality of different machine tools such as the machine tools 3, 3a, and 3b. The description is made on the premise that the storage unit 16 is disposed in the assistance device 10. However, of course, the storage unit 16 may be disposed in a place connectable from the assistance device 10 through a network (NW).

The machine tool 3 is, for example, a laser processing machine that performs processing by irradiation of a laser light. The machine tool 3 includes a control device 30, a processing device 38, and a sensor 39.

The control device 30 is a computer including an MPU (Micro Processing Unit) such as a microcomputer, for example. The control device 30 controls the operation of the processing device 38, based on the processing content information, and processes the workpiece.

The processing device 38 is a main body of a machine tool including a laser oscillator, a head driving mechanism, an assist gas injection mechanism, a workpiece installation mechanism, a user operation panel, and the like.

The sensor 39 is sensors for measuring a processing result or a processing environment, such as a camera, an X-ray CT (computed tomography), a vibration sensor, a displacement sensor, a thermometer, or a scanner. The sensor 39 may be included in the processing device 38, or may be a single sensor independent from the processing device 38. The sensor 39 measures the shape of a workpiece, a processing environment (temperature, vibration, position during processing), or the like.

In the machine tool 3, the control device 30 acquires the range information of the setting condition from the assistance device 10, and controls the operation of the processing device 38 while permitting only the setting condition within the acquired range. The control device 30 includes an input/output unit 31, a CAM (computer aided manufacturing) system 32, a sensor data processing unit 33, a processing device control unit 34, a setting condition determination unit 35, a communication unit 36, and a storage unit 37.

The input/output unit 31 receives input of operation information or a setting condition input from an operation panel by a user, or receives input of CAD data indicating the shape of the workpiece from the CAD system 2. The CAD data includes processing content information. Further, the input/output unit 31 outputs the range of the setting condition acquired from the assistance device 10 to a display provided on the operation panel.

The CAM system 32 creates NC (numerical control) data for processing from the CAD data acquired by the input/output unit 31.

The sensor data processing unit 33 generates processing result information by acquiring measurement information (a measured values or an image) obtained by measuring the workpiece by the sensor 39, calculating other information relating to the processing, as necessary, and the like. For example, the sensor data processing unit 33 calculates a hole diameter (diameter of a processing hole) by image analysis from a captured image of the workpiece, or calculates a taper angle by using the calculated hole diameter or the like.

The processing device control unit 34 controls the operation of the processing device 38, based on the NC data created by the CAM system 32, to perform processing.

The setting condition determination unit 35 determines whether or not the setting condition input by the user is included in the range of the setting condition acquired from the assistance device 10.

The communication unit 36 performs communication with the assistance device 10. For example, the communication unit 36 transmits the processing content information to the assistance device 10 and receives the range information of the setting condition corresponding to the transmitted processing content information from the assistance device 10.

The storage unit 37 stores information such as the range information of the setting condition acquired from the assistance device 10 and the CAD data acquired by the input/output unit 31.

The control device 30 presents to the user the ranges of the setting conditions (FIG. 2(b)) acquired from the assistance device 10, and the user selects a value that seems to be appropriate from among the ranges and inputs the value to the control device 30. The processing device control unit 34 determines to operate the processing device 38 according to this value (setting condition), and performs processing. The user selects a value from among the ranges of the setting conditions until the processing satisfying the processing specifications indicated by the processing contents becomes possible, and an operation in which the processing device 38 performs processing according to the setting condition is repeated. That is, the control device 30 operates the machine tool 3 on the premise of the specified range of the setting condition.

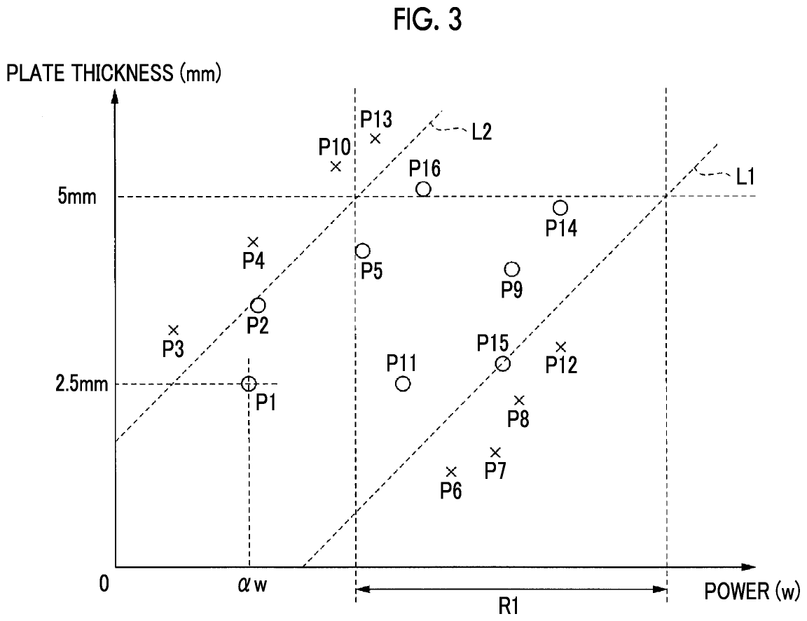

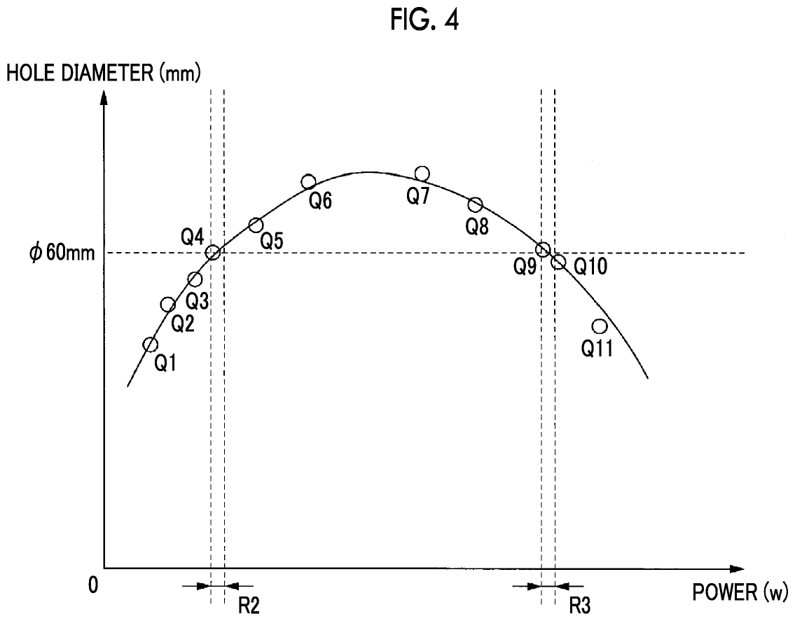

In this way, an appropriate setting condition for a certain processing content is determined, and the mass production of the workpiece becomes possible. Next, a range of a setting condition taking into account disturbance which is a feature of this embodiment will be described using FIGS. 3 and 4.

FIG. 3 is a first diagram for describing a range of a setting condition in the first embodiment of the present invention.

The graph of FIG. 3 is a graph showing the relationship between power (a setting condition), which is the output of a laser when a hole having a predetermined diameter is formed in a copper plate by a laser processing machine (the machine tool 3) and a plate thickness (a processing content). The vertical axis of the graph of FIG. 3 represents a thickness (mm) of a plate, and the horizontal axis represents power (w) of a laser. Each of marks P1 to P16 in the graph indicates a processing result when processing was performed in which a laser is output at the power indicated by the coordinate on the horizontal axis where the mark is located and a hole is formed in the copper plate having the plate thickness indicated by the coordinate on the vertical axis. Each of marks ○ and × indicates whether the processing was successful or unsuccessful. Specifically, the mark “○” indicates a result satisfying the processing content (success), and the mark “x” indicates a result not satisfying the processing content (failure). For example, the mark P1 indicates that a hole satisfying a predetermined processing content, for example, a hole having a good hole diameter or quality is formed when drilling is performed by outputting a laser of α (W) to a copper plate having a plate thickness of 2.5 (mm). From these processing results, if a boundary line that separates a case where the processing is successful from a case where the processing is unsuccessful is calculated using a predetermined method (statistical analysis, machine learning, or the like), for example, boundary lines L1 and L2 are obtained. The region sandwiched between the boundary lines L1 and L2 is considered to be a range of an appropriate value that can be set to the setting condition “power” in order to realize desired processing. For example, in a case where processing is performed on a copper plate having a plate thickness of 5 mm, it is considered that a range R1 sandwiched between the boundary lines L1 and L2 on the vertical axis 5 mm is an appropriate range of the laser power.

The storage unit 16 of the assistance device 10 stores the processing result information as illustrated in FIG. 3, and the range setting unit 12 performs processing of calculating the boundary lines L1 and L2 and processing of specifying the range (R1) of the setting condition corresponding to the processing content information (for example, plate thickness: 5 mm) to specify the range of the setting condition suitable for the processing content. The range setting unit 12 stores information on the specified range of the setting condition in the storage unit 16.

The processing relating to the marks P1 to P16 may be performed under various conditions. For example, even in members which are included in the category of a copper plate, there are various types of members according to the purity of copper, the type or content of components other than copper, a method of manufacturing the copper plate, and the like. Alternatively, also with respect to an environment in which the machine tool 3 performs processing, there are various environments. The range setting unit 12 specifies the range of the setting condition, based on processing results under various conditions that are not uniform. In this way, it is possible to specify the range of the setting condition taking into account disturbance affecting a processing result, such as an installation environment of a machine tool and an individual difference between workpieces.

For example, the processing results indicated by the marks P1 to P16 may be associated with information such as a processing time, a processing place, a material of a workpiece, a processing environment (temperature, humidity, vibration, or the like), the type and model number of the machine tool 3, and the total operation time (processing time) since the introduction of the machine tool 3, in addition to the processing content information (plate thickness or the like) and the setting condition information (power or the like). Then, the range setting unit 12 may specify the range of the setting condition by extracting only the processing result of the same material among the marks P1 to P16, based on the detailed information on the material of the workpiece, which is included in the processing content information acquired from the machine tool 3. Alternatively, the range setting unit 12 may specify the range of the setting condition by extracting only the processing result when performed in a similar processing environment, based on information on the processing environment included in the processing result information acquired from the machine tool 3. In this way, a more limited range of the setting condition can be provided in accordance with the actual processing condition, and the user of the machine tool 3 can perform the setting of the setting condition in a shorter time.

FIG. 4 is a second diagram for describing a range of a setting condition in the first embodiment of the present invention.

The graph of FIG. 4 is a graph showing the relationship between power (setting condition) which is the output of a laser when a hole is formed in a copper plate having a thickness of 5 mm by a laser processing machine, and a hole diameter (processing content). The vertical axis of FIG. 4 represents a hole diameter (mm), and the horizontal axis represents power (w) of a laser. Marks Q1 to Q11 in the graph indicate processing results when a laser is output with the power indicated by the coordinates on the horizontal axis where the marks are located, and indicate hole diameters of holes when the values indicated by the coordinates on the vertical axis are processed. For example, in a case of drilling a hole of ϕ60 mm, it indicates that as the power of the laser, a value included in a range R2 or a range R3 is suitable.

The storage unit 16 of the assistance device 10 stores processing result information as illustrated in FIG. 4, and the range setting unit 12 performs processing of specifying the ranges R2 and R3 as the ranges of the setting condition suitable for the processing content with respect the processing content such as forming a hole of ϕ60 mm.

The range setting unit 12 refers to the processing result stored in the storage unit 16 in a case where information such as “drilling a hole of ϕ60 mm in a copper plate having a thickness of 5 mm” is input, as the processing content, for example, and selects a common range (for example, R3) among the ranges of the setting conditions illustrated in FIGS. 3 and 4 or the ranges of the setting conditions specified based on other processing results relating to the power, thereby specifying a range for the setting condition “power” with respect to the processing content described above. The range setting unit 12 specifies a range also with respect to other setting conditions in the same manner.

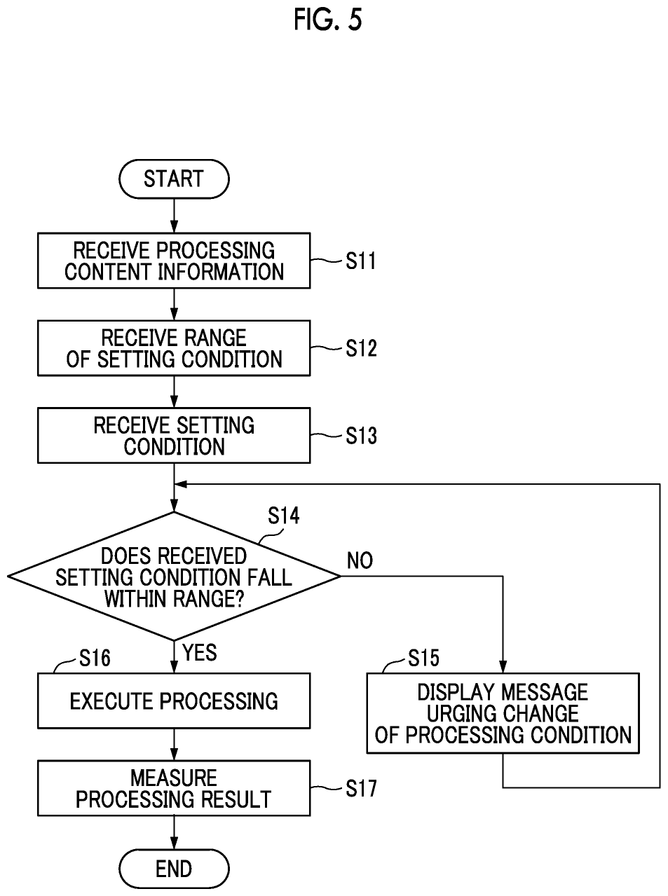

Next, processing of setting an appropriate setting condition on the machine tool 3 side, based on the range information of the setting condition provided by the assistance device 10, will be described using FIG. 5. The setting of the setting condition is performed for example, in a situation in which, when starting mass-production of a certain product, a setting condition dedicated to processing of the product is specified.

FIG. 5 is a flowchart showing an example of the processing of setting the setting condition using the range of the setting condition in the first embodiment of the present invention.

First, the CAD system 2 inputs CAD data including processing content information to the control device 30 by a user's operation. The input/output unit 31 receives the input of the processing content information (step S11) and stores the processing content information in the storage unit 37. Further, the communication unit 36 transmits the processing content information and a signal requesting the range information of the setting condition suitable for the processing content information to the assistance device 10. In the assistance device 10, as described using FIG. 3, the range setting unit 12 refers to the storage unit 16 and specifies the range of the setting condition corresponding to the processing content information. The communication unit 15 transmits the range information of the setting condition to the machine tool 3.

In the machine tool 3, the communication unit 36 receives the range information of the setting condition (step S12) and stores it in the storage unit 37.

Next, the user inputs setting condition information to the control device 30. The input/output unit 31 receives the input of the setting condition information (step S13) and outputs the setting condition information to the setting condition determination unit 35. The setting condition determination unit 35 compares the setting condition information input by the user with the range information of the setting condition received from the assistance device 10 to determine whether or not each of the setting conditions input by the user falls within the range of the setting condition (Step S14). In a case where there is a condition that at least one of the setting conditions input by the user does not fall within the range of the setting condition, the setting condition determination unit 35 creates a warning message (for example, “gas pressure is out of a range” or “please set a value within the range of X15-X16”) urging the user to change the setting condition, and outputs it to the input/output unit 31. The input/output unit 31 displays the warning message together with a message notifying that the machine tool cannot be operated, on the display of the control panel (step S15). The user inputs a value falling within the range of the setting condition to the control device 30.

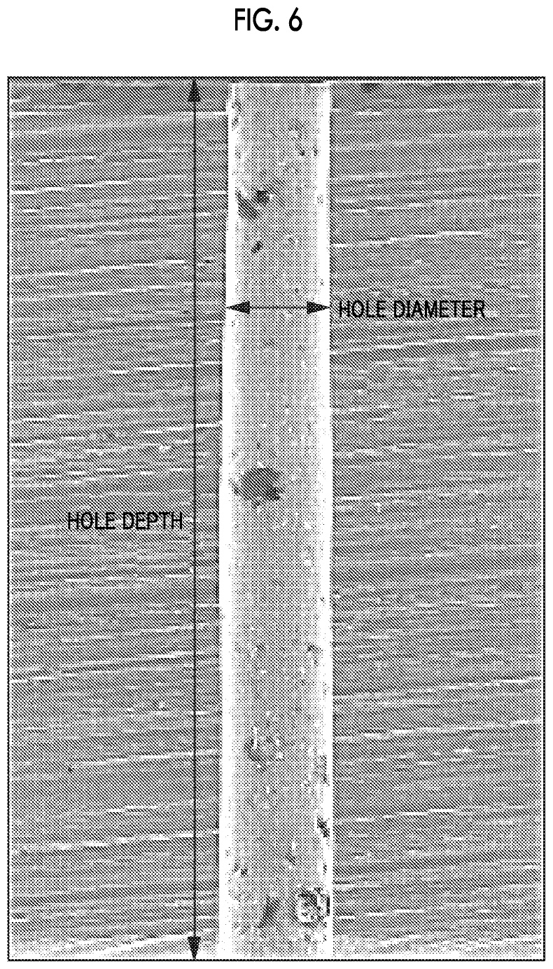

In a case where all of the setting conditions input by the user are within the range of the setting condition received from the assistance device 10, the user inputs an operation for instructing to execute processing to the control device 30. Then, the CAM system 32 creates NC data from the processing content information, and the processing device control unit 34 controls the operation of the processing device 38, based on the NC data and the input setting condition information, to execute the processing (step S16). When the processing is completed, the sensor 39 measures the processing result (Step S17). Here, the measurement of the processing result will be described using FIG. 6.

FIG. 6 is a diagram for describing the measurement of the processing result in the first embodiment of the present invention.

FIG. 6 shows an image obtained by photographing a result of processing for forming a tapered hole in a workpiece. A camera (sensor 39) photographs the inlet and the outlet of the tapered hole. The sensor data processing unit 33 calculates the diameter of the inlet and the diameter of the outlet through image analysis, based on the captured image. A known method is used as an image analysis method when calculating the diameter. Further, the sensor data processing unit 33 calculates the taper angle by dividing the difference between the inlet diameter and the outlet diameter by the depth of the hole (plate thickness). Further, the sensor data processing unit 33 may calculate surface roughness, an attached matter to the processed surface, the area of a deteriorated layer due to the processing, and the like by the image analysis. If the workpiece is photographed by the camera in this manner, it is possible to acquire a processing result. The sensor 39 which is used for the measurement of the processing result is not limited to the camera. For example, the user of the machine tool 3 may measure the hole diameter or the surface roughness by using a measuring instrument such as a gauge or a surface roughness meter and input the measurement result to the control device 30.

The sensor data processing unit 33 transmits the processing result information to the assistance device 10 through the communication unit 36. Further, the input/output unit 31 displays the processing result information on the display of the control panel. As will be described in a second embodiment, the processing result information can be used for evaluation of processing or adjustment of the range of the setting condition.

In the related art, there has been provided a method of providing a setting condition uniquely set with respect to a processing content to a user of the machine tool 3. However, in the case of this method, if a good processing result is not obtained by using the provided setting condition, it is difficult to know how to change the setting condition. For this reason, there is a possibility that a great deal of effort and time may be required to find an appropriate setting condition.

In contrast, according to this embodiment, the user repeats a process of coping with variations of various external factors acquired from the assistance device 10, selecting a value within an appropriate range of the setting condition corresponding to the processing content, setting the selected value for each item of the setting conditions, performing the processing, and verifying the processing result. In this way, it is possible to reliably find an appropriate setting condition in a shorter time.

Further, in the method of the related art, unless setting conditions corresponding to processing contents are registered, in many cases, it is not possible to provide the user of the machine tool 3 with a setting condition which seems to be appropriate. However, according to the control method of this embodiment, the range setting unit 12 flexibly calculates a range of a setting condition corresponding to a processing content by a method such as interpolation calculation or extrapolation, based on the past processing result information, and therefore, it is possible to cope with various processing contents.

### Second Embodiment

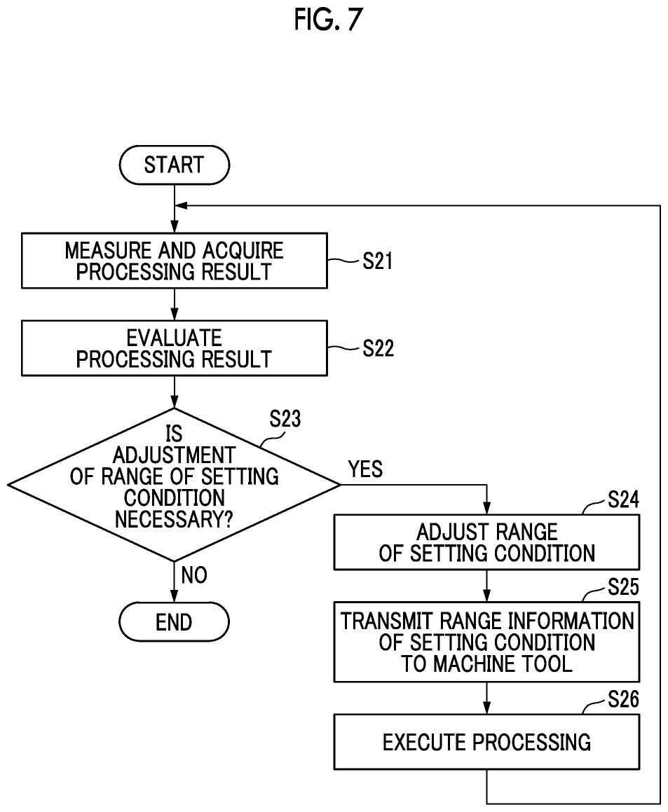

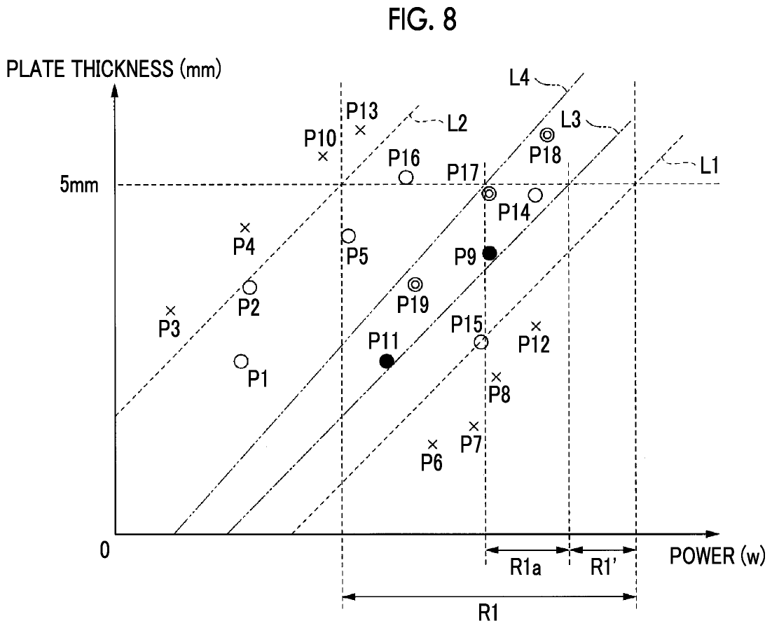

In the first embodiment, it is on the premise that it is possible to find an appropriate setting condition within the range of the setting condition which is provided by the assistance device 10. However, there is a case where even if a range of a setting condition is provided, it is difficult to find an appropriate setting condition, such as a case where processing is performed on a new material that has not been used in the past. For example, when a lot of copper alloy processing result information is stored and a range of a setting condition which is provided by the assistance device 10 is a range of a condition more suitable for a copper alloy, in a case of starting processing using a copper plate made of pure copper, there is a possibility that the range of the setting condition which is provided by the assistance device 10 may deviate from the range of the setting condition suitable for a copper plate made of pure copper. In order to cope with such a situation, in the second embodiment, a function of feeding back a processing result and adjusting a range of a setting condition is provided. The range setting unit 12 of the second embodiment has a function of adjusting the specified range of the setting condition. Next, the processing of adjusting a range of a setting condition by the range setting unit 12 will be described using FIGS. 7 and 8.

FIG. 7 is a flowchart showing an example of the processing of adjusting a range of a setting condition in the second embodiment of the present invention.

The machine tool 3 performs processing according to the processing content information and the input setting condition, and the sensor 39 performs measurement of the processing result. As an example, it is assumed that the processing content is to form a hole in a copper plate made of pure copper and having a plate thickness of 5 mm. Further, the range of the setting information specified by the method described with reference to FIGS. 3 and 4 is provided to the machine tool 3, and the machine tool 3 performs processing by performing an operation within the range. The communication unit 36 transmits the processing content information and the processing result information acquired from the sensor data processing unit 33 to the assistance device 10. In the assistance device 10, the communication unit 15 acquires the processing result information and the processing content information (step S21), and outputs the information to the processing result evaluation unit 13.

The processing result evaluation unit 13 compares the processing result information with the processing content information to evaluate the processing result (step S22). For example, the taper angle determined in the processing content is compared with the taper angle included in the processing result information, and if the difference is within a predetermined allowable range (for example, a tolerance), the taper angle is evaluated as being successful, and if it is out of the allowable range, the taper angle is evaluated as being unsuccessful. The processing result evaluation unit 13 also evaluates the processing result with respect to other items included in the processing content.

Next, the range evaluation unit 14 determines whether or not adjustment of the range of the setting condition is necessary (step S23). For example, the range evaluation unit 14 evaluates that the range of the setting condition is not appropriate, with respect to the setting condition evaluated that processing is unsuccessful, by the processing result evaluation unit 13. Alternatively, the range evaluation unit 14 may evaluate that the range of the setting condition is not appropriate, with respect to the setting condition evaluated as failure for a certain number or more times among the predetermined number of times of processing.

In a case where it is evaluated that the range of the setting condition is appropriate (step S23; No), because the adjustment of the range of the setting condition is unnecessary, the processing of this flowchart is ended.

In a case where it is evaluated that the range of the setting condition is not appropriate (Step S23; Yes), the range setting unit 12 adjusts the range of the setting condition (Step S24). Here, the processing of step S24 will be described using FIG. 8. FIG. 8 is a diagram for describing adjustment of a range of a setting condition in the second embodiment of the present invention. The graph of FIG. 8 is a graph in which new processing result information is added to the graph of FIG. 3. Further, among the marks P1 to P16, the marks P9 and P11 are processing results on a copper plate made of pure copper, and the other marks are processing results on a copper plate made of a copper alloy. Further, the marks P17 to P19 are the processing results on the copper plate made of pure copper added afterwards. Further, pure copper is designated as the “material” of the processing content with respect to the current processing. Further, when the user sets a certain value in a range R1′ (the range R1′ is within the range R1 provided from the assistance device 10) to the setting condition “power” and gives a processing instruction, It is assumed that the evaluation result by the processing result evaluation unit 13 with respect to the processing is failure. Then, the range setting unit 12 refers to the processing result information (FIG. 8) stored in the storage unit 16 and extracts the processing result using pure copper, based on the information about the “copper plate made of pure copper” included in the current processing content. In this way, the processing results of the marks P9, P11, and P17 to P19 are extracted. The range setting unit 12 calculates boundary lines L3 and L4 after adjustment for the marks P9, P11 and P17 to P19. Then, the range setting unit 12 specifies the range (R1a) of the setting condition after the adjustment, based on the information of “plate thickness: 5 mm” included in the processing content. The range setting unit 12 stores the range information of the setting condition after the adjustment in the storage unit 16. The range setting unit 12 adjusts the range by performing the same adjustment processing on the processing result indicating the relationship between the setting condition “power” and another processing content (for example, “hole diameter”), and finally calculates a common range for all the setting conditions as a final range of a setting condition.

The range setting unit 12 stores the range information of the setting condition after the adjustment calculated in this way in the storage unit 16.

The range setting unit 12 transmits the range information of the setting condition to the machine tool 3 through the communication unit 15 (Step S25). In the machine tool 3, the communication unit 36 acquires the range information of the setting condition after the adjustment and stores it in the storage unit 37. Further, the input/output unit 31 displays the range information of the setting condition after the adjustment on the display. The user refers to the newly set range information of the setting condition after the adjustment and inputs the setting condition more suitable for the processing of a copper plate made of pure copper. The machine tool 3 performs processing according to the input setting conditions (step S26). The processing from step S21 is repeated until the range of the setting condition is appropriately adjusted.

According to the control method of this embodiment, it is possible to confirm, by actual processing, whether or not the range of the setting condition specified based on the past processing results is appropriate. Further, by specifying the range of the setting condition including the processing result on the actual workpiece, it is possible to adjust the range of the setting condition to more closely match the actual situation. Further, by repeatedly performing the feedback of the processing result, it is possible to continuously perform narrowing-down of the range of the setting condition taking into account the influence of disturbance. Although FIG. 8 shows an example in which the range of the setting condition is narrowed down based on the material of the workpiece, similarly, the narrowing-down (adjustment) of the range of the setting condition may be performed based on the processing result information performed in a similar processing environment, based on the processing environment information stored together with the processing result information. Alternatively, the adjustment of the range of the setting condition may be performed by extracting the processing result information by the machine tool 3 in which the total operation time stored together with the processing result information is approximately the same extent as that in the own machine tool.

### Third Embodiment

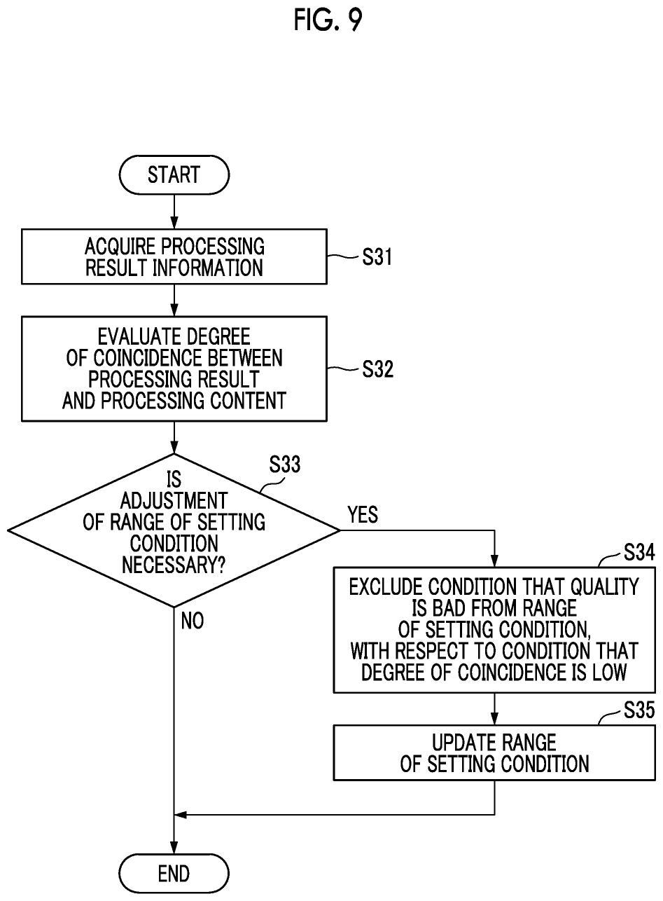

In the second embodiment, the function of adjusting the range of the setting condition which is first set for the processing which is newly started has been described. Even after the processing is performed for a while within the range of the setting conditions set in this way, due to a secular change (deformation of a gas nozzle, deterioration of a lens, clogging of a pipe, or the like) occurring in the machine tool 3 or the influence of the malfunction of the device, there is a case where the range of the setting condition which was initially appropriate gradually become unsuitable. In a third embodiment, a function is provided in which even after a mass production system is established with respect to a certain processing content, by continuously feeding back the processing results, whether or not the processed quality maintains a certain criterion is monitored, and when a situation is created in which the quality cannot be maintained due to a secular change or the like if processing is performed in the range of the setting condition so far, the range of the setting condition suitable for the current situation is reset. Next, processing of resetting the range of the setting condition by the range setting unit 12 in this embodiment will be described using FIGS. 9 to 11.

FIG. 9 is a first flowchart showing an example of the processing of resetting the range of the setting condition in the third embodiment of the present invention.

Similar to the processing described with reference to FIG. 7, the machine tool 3 performs the processing according to the processing content information and the input setting condition, and transmits the processing result information and the processing content information to the assistance device 10. In the assistance device 10, the communication unit 15 acquires the processing result information and the processing content information (step S31), and outputs the information to the processing result evaluation unit 13.

The processing result evaluation unit 13 compares the processing result information with the processing content information to evaluate the degree of coincidence between the processing result and the processing content (step S32). For example, a difference between the taper angle defined in the processing content and the taper angle included in the processing result information is calculated, and if the difference is equal to or less than a predetermined threshold value, the degree of coincidence with respect to the taper angle is evaluated to satisfy the criterion (quality Is maintained), and if the difference is larger than the threshold value, the degree of coincidence is evaluated not to satisfy the criterion.

Next, the range evaluation unit 14 determines whether or not the adjustment of the range of the setting condition is necessary (step S33). For example, the range evaluation unit 14 evaluates that the range of the setting condition is not appropriate, with respect to the setting condition evaluated by the processing result evaluation unit 13 that the degree of coincidence does not satisfy the criterion. Alternatively, the range evaluation unit 14 may evaluate that the range of the setting condition is not appropriate, with respect to the setting condition evaluated that the degree of coincidence does not satisfy the criterion for a certain number of times or more among the predetermined number of times of processing.

In a case of being evaluated that the range of the setting condition is appropriate (step S33; No), because the adjustment of the range of the setting condition is unnecessary, the processing of this flowchart is ended.

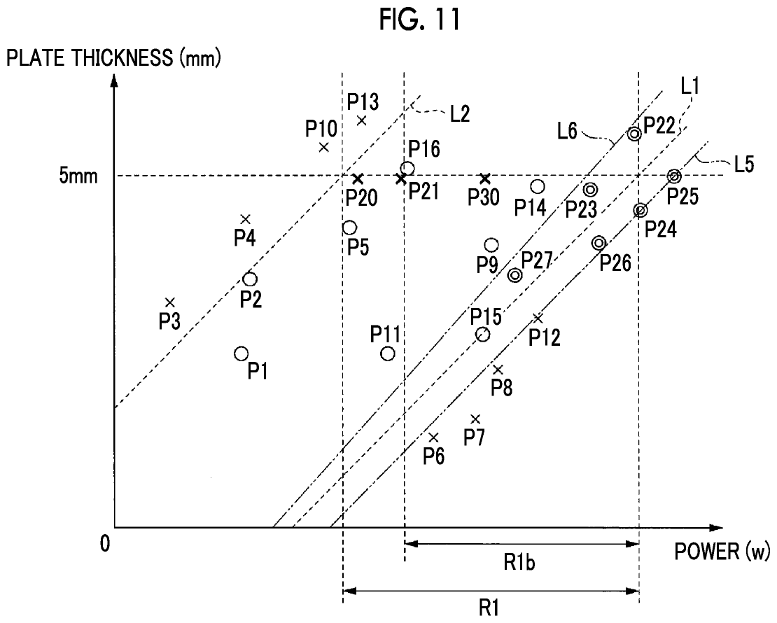

In a case of being evaluated that the range of the setting condition is not appropriate (Step S33; Yes), the range setting unit 12 adjusts the range of the setting condition (Step S34). Here, the process of step S34 will be described by taking an example using FIG. 11. FIG. 11 is a diagram for describing the resetting of the range of the setting condition in the third embodiment of the present invention. The graph of FIG. 11 is a graph in which new processing result information (marks P20 and P21 and the like) is added to the graph of FIG. 3. The marks P20 and P21 are processing results by the machine tool 3. For example, when the mechanism is deformed by the impact of hitting an object on the processing device 38, or the like, there is a case where the previous quality is not obtained suddenly, even if the processing is performed under the same setting conditions as before. The processing results indicated by the marks P20 and P21 show that the quality was not good even though the processing was performed according to the setting condition that was initially confirmed to be appropriate. In such a case, the range evaluation unit 14 evaluates that the range of the setting condition is no longer appropriate. Then, the range setting unit 12 refers to the processing results (FIG. 11) stored in the storage unit 16 and specifies, for example, a range R1b in which the marks P20 and P21 that are failure are excluded, as a range of a setting condition according to the current state of the machine tool 3. The range setting unit 12 stores information on the specified range of the setting condition in the storage unit 16. The range setting unit 12 performs the same re-specifying processing also with respect to the processing result indicating the relationship between the setting condition “power” and another processing content (for example, “hole diameter”), finally calculates a common range for all the setting conditions, and specifies the final range of the setting condition. The range setting unit 12 stores the range information of the setting condition after the re-specification in the storage unit 16 and updates (resets) the range of the setting condition (step S35).

The assistance device 10 transmits information on the reset range of the setting condition to the machine tool 3. If the new setting condition range information is acquired, the machine tool 3 displays a message such as “the range of the setting condition has been updated” on the display, and urges the user to re-enter the setting condition. Thereafter, as described in the first and second embodiments, the user adjusts the range of the setting condition as needed to search for a new setting condition. Then, the processing is continued while the feedback of the processing result is performed.

According to this embodiment, it is possible to specify the range of the setting condition corresponding to a trouble of the machine tool 3 or a change in the processing environment that occurs during the processing. Therefore, even when a trouble or the like of the machine tool 3 occurs and the setting condition needs to be reset, it is possible to find an appropriate setting condition in a short time, and thus it is possible to save labor. Further, the setting conditions can be reset in a short time, so that the influence on mass production processing can be minimized.

Further, by repeatedly performing the feedback of the processing result, it is possible to continuously perform narrowing-down of the range of the setting condition taking into account the influence of disturbance. Further, If the relationship between a change in the processing result and an abnormal location occurring in the machine tool 3 is known in advance, by monitoring the setting conditions (power) continuously stored with respect to a certain processing content (plate thickness), as shown in FIG. 11, and the change of the processing result, it is possible to predict the failure of the machine tool 3 or determine whether the machine tool 3 has failed.

Next, another example of the processing of resetting the range of the setting condition will be described.

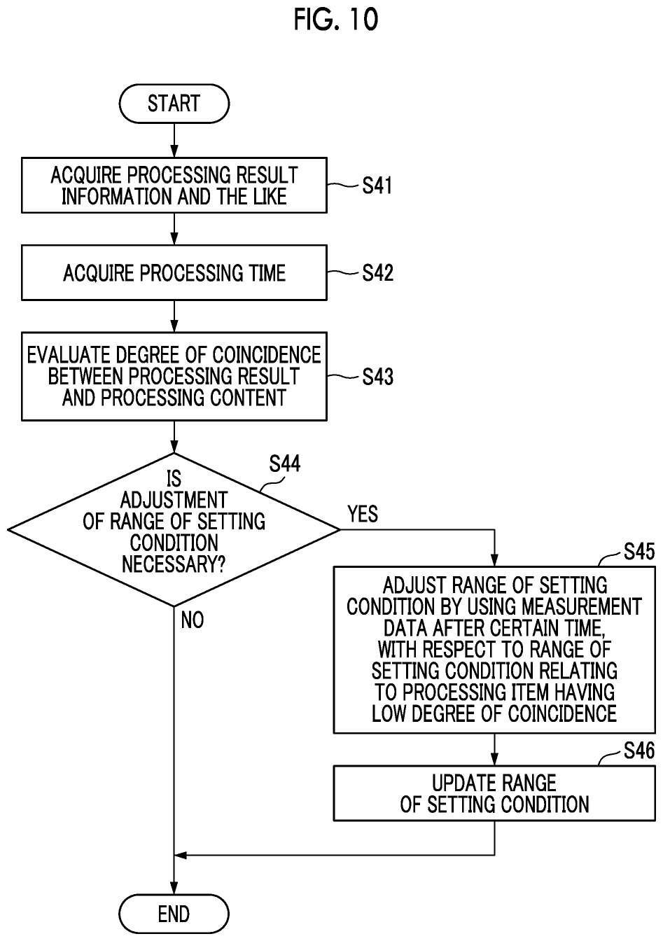

FIG. 10 is a second flowchart showing an example of the processing of resetting the range of the setting condition in the third embodiment of the present invention.

In the description of FIG. 10, it is assumed that the machine tool 3 and the machine tools 3a and 3b are considered separately and a target for adjustment of the range of the setting condition is the machine tool 3. Further, it is on the premise that the machine tool 3 and the machine tools 3a and 3b are of the same model, the total processing time (operating time), processing environments, and the like of the three machine tools are relatively close to each other, and the machine tools 3, 3a and 3b can be estimated to undergo a similar secular change.

The machine tool 3 performs processing in the same manner as the processing described in FIG. 9, and the communication unit 15 of the assistance device 10 acquires the processing result information and the processing content information (step S41). Further, the communication unit 15 acquires a processing time relating to the processing (step S42). The communication unit 15 stores the processing result information and the processing content information in association with the processing time in the storage unit 16. Next, the processing result evaluation unit 13 evaluates the degree of coincidence between the processing result and the processing content (step S43). Next, the range evaluation unit 14 determines whether or not the adjustment of the range of the setting condition is necessary (step S44). In a case where the range of the setting condition is appropriate (Step S44; No), the processing of this flowchart is ended.

In a case where the range of the setting condition is not appropriate (Step S44; Yes), the range setting unit 12 adjusts the range of the setting condition (Step S45). Here, the processing of resetting the range of the setting condition taking into account a secular change of the machine tool 3 will be described using to FIG. 11. In the graph of FIG. 11, marks P22 to P27 are processing result information recently received from the machine tools 3a and 3b. Marks (double circles) of the marks P22 to P27 indicate that processing of these has been successful, and the processing time is stored in association with each processing result. On the other hand, a mark P30 is the latest processing result information received from the machine tool 3, and a mark x of the mark P30 indicates that the current processing has failed. In such a case, the range evaluation unit 14 evaluates that the range of the setting condition is not appropriate. Then, the range setting unit 12 refers to the processing result information (FIG. 11) stored in the storage unit 16, compares the processing time stored in association with each processing result with the processing time acquired in step S42, and extracts only the processing results performed within a predetermined period on the basis of the current processing time. In this way, the processing results of the marks P22 to P27 are extracted. The range setting unit 12 calculates boundary lines L5 and L6 after adjustment for the marks P22 to P27. Then, the range setting unit 12 specifies the range (R1b) of the setting condition, based on the information of “plate thickness: 5 mm” included in the processing content. The range setting unit 12 stores information on the specified range of the setting condition in the storage unit 16. The range setting unit 12 performs the same re-specifying processing also with respect to the processing result indicating the relationship between the setting condition “power” and another processing content (for example, “hole diameter”), finally calculates a common range for all the setting conditions, and specifies the final range of the setting condition. The range setting unit 12 stores the range information of the setting condition after the resetting in the storage unit 16 and updates (resets) the range of the setting condition (step S46). According to the processing described with reference to FIG. 10, it is possible to provide the range of the setting conditions taking into account a secular change situation. Further, the operating time of the machine tool 3 is stored in association with the reset range of the setting condition, whereby, for example, when another machine tool introduced after the machine tool 3 undergoes a similar secular change, the stored range of the setting condition can be applied to the machine tool as well.

In the embodiments described above, a case where the machine tool 3 is a laser processing machine has been described as an example. However, the processing of providing the range of the setting condition or the processing of adjustment, resetting, or the like of the range of the setting condition in the first to third embodiments may be performed in another processing machine as the machine tool 3. For example, the machine tool 3 may be a machine that performs cutting, such as a machining center or an NC lathe. The processing content in this case is, for example, the type of a material, tensile strength, hardness, a hole diameter, a plate thickness, or the like. Further, the setting condition is, for example, the type of a cutting tool, the number of rotations of a spindle, a feed speed of a linear moving shaft, the presence or absence, type, or discharge pressure of cutting water or cutting oil (coolant), or the like. If the control system 1 of this embodiment is applied to a cutting machine, the assistance device 10 provides an appropriate range of a value to be set to each of the setting conditions described above to the machine tool 3 side. The user can perform the setting of the setting condition in a short time.

Further, in the embodiments described above, it is assumed that the range of the setting condition is received from the assistance device 10. However, a configuration may be made such that the user can arbitrarily register an appropriate range of a setting condition to the machine tool 3 owned by the user' company through the input/output unit 31. The range information of the setting condition arbitrarily registered by the user may be stored in the storage unit 37 or may be stored in the storage unit 16 for each user and each machine tool. Further, the range information of the setting condition arbitrarily registered by the user may be a part of the range information of the setting condition received from the assistance device 10 or may include a range different from the range information of the setting condition received from the assistance device 10.

(Hardware Configuration)

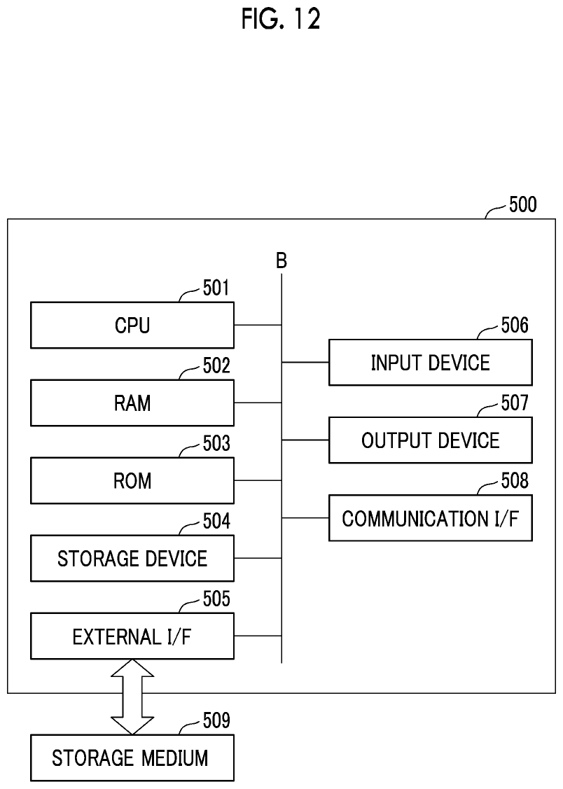

The assistance device 10 and the control device 30 can be realized using a general computer 500. FIG. 12 shows an example of the configuration of the computer 500.

FIG. 12 is a diagram showing an example of a hardware configuration of the control device and the assistance device according to the present invention.

The computer 500 includes a CPU (Central Processing Unit) 501, a RAM (Random Access Memory) 502, a ROM (Read Only Memory) 503, a storage device 504, an external I/F (Interface) 505, an input device 506, an output device 507, and a communication I/F 508, and the like. These devices mutually transmit and receive signals through a bus B.

The CPU 501 is an arithmetic device that realizes each function of the computer 500 by reading out a program or data stored in the ROM 503, the storage device 504, or the like onto the RAM 502 and executing processing. For example, each of the above functional parts is a function which is provided to the computer 500 when the CPU 501 reads and executes a program stored in the ROM 503 or the like. The RAM 502 is a volatile memory which is used as a work area or the like of the CPU 501. The ROM 503 is a non-volatile memory that retains a program or data even when the power is turned off. The storage device 504 is realized by, for example, a HDD (Hard Disk Drive), an SSD (Solid State Drive), or the like and stores an OS (Operation System), an application program, a variety of data, and the like. The external I/F 505 is an interface with an external device. The external device includes, for example, a storage medium 509, or the like. The computer 500 can perform reading and writing of the storage medium 509 through the external I/F 505. The storage medium 509 includes, for example, an optical disk, a magnetic disk, a memory card, a USB (Universal Serial Bus) memory, and the like.

The input device 506 includes, for example, a mouse, a keyboard, and the like and inputs various operations or the like to the computer 500 in response to an operator's instruction. The output device 507 is realized by, for example, a liquid crystal display and displays a processing result by the CPU 501. The communication I/F 508 is an interface that connects the computer 500 to a network such as the Internet by wire communication or wireless communication. The bus B is connected to each of the above components, and transmits and receives various signals and the like between the components.

The process of each processing in the assistance device 10 and the control device 30 described above is stored in a computer-readable storage medium in the form of a program, and this program is read out and executed by the computer 500 mounted with each device (the assistance device 10 and the control device 30), whereby the above processing is performed. Here, the computer-readable storage medium refers to a magnetic disk, a magneto-optical disk, a CD-ROM, a DVD-ROM, a semiconductor memory, or the like. Alternatively, a computer program may be distributed to a computer by a communication line, and the computer that has received the distribution may execute the program.

Further, the program may be for realizing some of the functions described above. Further, the program may be a program capable of realizing the functions described above in combination with a program already stored in a computer system, that is, a so-called differential file (differential program).

Further, the assistance device 10 and the control device 30 may be configured with a single computer, or may be configured with a plurality of computers communicably connected to each other. Further, the function parts (the range setting unit 12, the processing result evaluation unit 13, the range evaluation unit 14, and the storage unit 16) of the assistance device 10 may be mounted in the control device 30.

In addition, it is possible to appropriately replace the components in the above-described embodiments with known components within a scope which does not depart from the gist of the present invention. Further, the technical scope of the present invention is not limited to the embodiments described above, and various modifications can be made within a scope which does not depart from the gist of the present invention. The assistance device 10 is an example of a machine tool setting assistance device. The control device 30 is an example of a machine tool control device. The input/output unit 31 is an example of a reception unit. The setting condition determination unit is an example of a specifying unit. The processing device control unit 34 is an example of a determination unit.

### INDUSTRIAL APPLICABILITY

According to the above-described machine tool control method, machine tool control device, machine tool setting assistance device, machine tool control system, and program, by providing an appropriate range of a setting condition determined in consideration of disturbance, it is possible to perform setting of the setting condition for the machine tool in a shorter time.

### REFERENCE SIGNS LIST

1: control system

2, 2a, 2b: CAD system

3, 3a, 3b: machine tool

10: assistance device

11: data acquisition unit

12: range setting unit

13: processing result evaluation unit

14: range evaluation unit

15: communication unit

16: storage unit

30: control device

31: Input/output unit

32: CAM system

33: sensor data processing unit

34: processing device control unit

35: setting condition determination unit

36: communication unit

37: storage unit

38: processing device

39: sensor

1-14. (canceled)

15. A machine tool control method comprising:
a step of receiving a processing content for a workpiece;
a step of referring to a storage unit in which a range of a setting condition relating to an operation of a machine tool for performing processing is stored for each processing content, and specifying the range of the setting condition corresponding to the received processing content;
a step of determining setting for an operation of the machine tool on the premise of the specified range of the setting condition, in a case of receiving a processing instruction according to the processing content for the workpiece;
a step of acquiring information indicating a result of processing of the workpiece;
a step of evaluating the result of processing, based on the processing content;
a step of adjusting the range of the setting condition, based on the evaluation; and
a step of storing the adjusted range of the setting condition in the storage unit.

16. The machine tool control method according to claim 15, wherein the information indicating a result of processing of the workpiece is measurement information obtained by measuring an environment in which the processing is performed or the workpiece by using a sensor, or a value calculated based on the measurement information.

17. The machine tool control method according to claim 15, further comprising:
a step of evaluating the range of the setting condition, based on the result of processing and the processing content; and
a step of resetting the range of the setting condition in a case where in the evaluation, it is determined that the range of the setting condition is not appropriate.

18. The machine tool control method according to claim 17, wherein in the step of evaluating the range of the setting condition, a degree of coincidence between a request included in the processing content and a result of the processing with respect to the request is calculated, and if the degree of coincidence is equal to or less than a predetermined threshold value, it is determined that the range of the setting condition is not appropriate.

19. The machine tool control method according to claim 17, wherein in the step of acquiring information indicating a result of processing, information on a time when the processing was performed is further acquired, and
in the step of resetting the range of the setting condition, the range of the setting condition is reset based on the information indicating the result of processing acquired within a predetermined period on the basis of the acquired time.

20. The machine tool control method according to claim 15, further comprising:
a step of notifying that the machine tool is not able to be operated under the setting condition as instructed, in a case of receiving an instruction to operate the machine tool under a setting condition outside the range of the setting condition.

21. The machine tool control method according to claim 15, wherein the processing content includes at least one of a material of the workpiece, a size of a hole which is formed in the workpiece, and a thickness of the workpiece.

22. The machine tool control method according to claim 15, wherein the machine tool is a laser processing machine.

23. A machine tool control device comprising:
a reception unit that receives a processing content for a workpiece;
a specifying unit that refers to a storage unit in which a range of a setting condition relating to an operation of a machine tool for performing processing is stored for each processing content, and specifies the range of the setting condition corresponding to the received processing content;
a determination unit that determines setting for an operation of the machine tool on the premise of the specified range of the setting condition, in a case of receiving a processing instruction according to the processing content for the workpiece; and
a range setting unit that evaluates the result of processing of the workpiece based on the processing content for the of the workpiece and sets a range of the setting condition based on the evaluation.

24. A machine tool setting assistance device comprising:
a storage unit in which a processing content for a workpiece and a range of a setting condition of a machine tool are stored in association with each other; and
a range setting unit that sets the range of the setting condition, based on a result of processing of the workpiece according to a predetermined processing content by the machine tool and the processing content.

25. A machine tool control system comprising:
the machine tool control device according to claim 23; and
the machine tool setting assistance device according to claim 24,
wherein the control device specifies the range of the setting condition associated with the processing content with reference to a storage unit included in the setting assistance device.

26. A program for causing a computer of a machine tool control device to execute:
a step of receiving a processing content for a workpiece;
a step of referring to a storage unit in which a range of a setting condition relating to an operation of a machine tool for performing processing is stored for each processing content, and specifying the range of the setting condition corresponding to the received processing content;
a step of determining setting for an operation of the machine tool on the premise of the specified range of the setting condition, in a case of receiving a processing instruction according to the processing content for the workpiece;
a step of acquiring information indicating a result of processing of the workpiece;
a step of evaluating the result of processing, based on the processing content;
a step of adjusting the range of the setting condition, based on the evaluation; and
a step of storing the adjusted range of the setting condition in the storage unit.
